(19) United States
(12) Patent Application Publication
(10) Pub. No.: US 2026/0213385 A1
(43) Pub. Date: Jul. 23, 2026

(54) ENERGY STORAGE SYSTEM COMPRISING A COOLING SYSTEM

(71) Applicant: POLARIUM ENERGY SOLUTIONS AB, Stockholm (SE)

(72) Inventors: Erik EDBERG, Stockholm (SE); Kenneth LINDGREN, Stockholm (SE)

(21) Appl. No.: 19/139,534

(22) PCT Filed: Dec. 18, 2023
(86) PCT No.: PCT/EP2023/086459

§ 371 Date: Jun. 16, 2025

(30) Foreign Application Priority Data
Dec. 22, 2022 (EP) 22216161.4

(51) Int. Cl. H01M 50/609; H01M 10/48; H01M 10/613; H01M 10/627; H01M 10/63; H01M 10/6568; H01M 50/251; H01M 50/673

(52) U.S. Cl. CPC H01M 50/609; H01M 10/486; H01M 10/613; H01M 10/627; H01M 10/63; H01M 10/6568; H01M 50/251; H01M 50/673

(57) ABSTRACT

An energy storage system (100) is provided. The energy storage system comprises at least one battery stack (102) comprising at least one battery module (104). Each of the at least one battery module comprises a plurality of temperature sensors. The energy storage system further comprises a cooling system (106). The cooling system comprises a pressurized cooling medium source (110), a channel system (108) arranged to selectively provide cooling medium from the cooling medium source to each of the at least one battery module by means of a valve system, and a cooling system controller. The cooling system controller is configured to determine, based on signals received from the temperature sensors of said at least one battery module, that a battery module is in thermal runaway; and activate the valve system to selectively release a predefined amount of cooling medium into the battery module in thermal runaway.

### TECHNICAL FIELD

The present disclosure relates generally to the field of energy storage systems. More specifically, it relates to an energy storage system comprising a cooling system, and a method for cooling a battery module in an energy storage system.

### BACKGROUND

Energy storage systems, such as battery systems and especially high-voltage battery systems, are subject to rigorous safety standards. One such standard relates to fire safety and provides that if a battery module in a stack is in thermal runaway, the thermal runaway may not spread to neighboring stacks. Different solutions exist today which attempt to fulfil this requirement. Some solutions include isolating neighboring stacks from one another, placing stacks far apart, or using sprinkler systems to spray water over the stacks to cool them in case of thermal runaway.

However, the existing solutions have different types of drawbacks. Some existing solutions require large spaces for the battery installations in order to provide sufficient distance between the stacks. Other solutions require expensive materials to isolate the stacks. Solutions involving sprinkler systems may run a risk of water damaging the surrounding site and/or neighboring, non-affected stacks. Further, external sprinkler systems are often triggered when a module has already caught fire, at which point the risk of fire spreading is already at a high level.

### SUMMARY

It is therefore an object of the present invention to overcome at least some of the above-mentioned drawbacks, and to provide an improved method and system for cooling battery modules.

This and other objects are achieved by means of an energy storage system, and a method as defined in the appended independent claims. Other embodiments are defined by the dependent claims.

According to a first aspect of the present disclosure, an energy storage system is provided. The energy storage system comprises at least one battery stack comprising at least one battery module. Each of the at least one battery module comprises a plurality of temperature sensors. The energy storage system further comprises a cooling system. The cooling system comprises a pressurized cooling medium source, a channel system arranged to selectively provide cooling medium from the cooling medium source to each of the at least one battery module by means of a valve system, and a cooling system controller. The cooling system controller is configured to determine, based on signals received from the temperature sensors of said at least one battery module, that a battery module is in thermal runaway. The cooling system controller is further configured to activate the valve system to selectively release a predefined amount of cooling medium into the battery module in thermal runaway.

The present energy storage system comprises a cooling system using detection of thermal deviation/runaway inside a battery module and provides cooling inside the battery module using a limited amount of cooling medium. Energy storage systems according to the first aspect may fulfil the requirements of the fire safety standards without additional safety distance between the stacks.

The temperature sensors may be arranged inside the battery module. Specifically, the plurality of temperature sensors may be distributed within the battery module. Arranging a plurality of sensors inside the battery module may provide an earlier detection of thermal events (or temperature changes) in the battery module. When detection is made early, less cooling medium may be used to cool the overheating cells prior to any fire erupting. Earlier detection may also limit the risk for adjacent modules to overheat. For example, the temperature increase may be detected before the temperature change has reached a cover of the battery module. This may, in turn, limit the amount of cooling agent necessary, as only one module may need to be cooled. For example, the temperature sensors may be arranged in thermal contact with, or at least in proximity to, a battery cell pack of the battery module for detection as to whether one or more cells of the battery cell pack is subject to thermal runaway.

The cooling system controller may be part of an energy storage system (ESS) controller or a battery management system (BMS). For example, processes performed by the cooling system controller may be implemented in an ESS controller, a BMS, or in a separate cooling system controller.

In the present disclosure, a battery module in which a thermal event, or temperature increase, or thermal runaway has been detected may be referred to as a faulty module.

According to some embodiments, the predefined amount of cooling medium may correspond to the volume of a single battery module.

Limiting the amount of cooling medium released into the faulty module may reduce the risk of water damage to other modules and/or an area surrounding the energy storage system. The predefined amount of cooling medium may be adapted to at least fill a single battery module. For example, the predefined amount of cooling medium may correspond to the volume of a single battery module as determined by the housing (e.g., in the form of a box) of the battery module in which the battery cell pack is located. Potentially, the predefined amount may be slightly larger than the volume of a module, such as 5-10% larger.

According to some embodiments, the cooling medium source may be a pressurized tank comprising the predefined amount of cooling medium.

Embodiments including a pressurized tank as a cooling medium source may provide a standalone energy storage system.

The pressurized tank may comprise the predefined amount of cooling medium. The pressurized tank may comprise a larger amount of cooling medium. The pressurized tank may be provided with a flow sensor or a timer in communication with the cooling system controller, allowing the cooling system controller to inject a controlled amount of cooling medium into the faulty module.

According to some embodiments, the cooling medium may be water.

According to some embodiments, the cooling medium source may be a water supply.

The cooling system may further comprise a flow sensor. The cooling system controller may further be configured to stop the water supply or other pressurized cooling medium source when the predefined amount has been released into the battery module, based on an input from the flow sensor.

For example, the cooling system may comprise a cooling medium source valve. The cooling system controller may open the cooling medium source valve to selectively release cooling medium into a faulty module. The cooling system controller may determine, based on an input from the flow sensor, that the predefined amount of cooling medium has been released into the (faulty) battery module. Upon determination that the predefined amount has been released, the cooling system controller may close the cooling medium source valve. For example, the cooling system may comprise a water supply valve. The cooling system controller may open the water supply valve to selectively release water into a faulty module. The cooling system controller may determine, based on an input from the flow sensor, that the predefined amount of water (cooling medium) has been released into the (faulty) battery module. Upon determination that the predefined amount has been released, the cooling system controller may close the water supply valve.

If the flow of the water supply is known, the flow sensor may be replaced by a timer to limit the opening time of the water supply valve or cooling medium source valve. For example, the cooling system controller may determine, based on an input from the timer, that, that the predefined amount of cooling medium has been released into the (faulty) battery module.

According to some embodiments, the channel system may include a dedicated channel for each of the at least one battery module. The valve system may include a plurality of individually controllable module valves. Each of the individually controllable module valves may be arranged in connection with a respective dedicated channel and configured to control a cooling medium flow from the cooling medium source to the respective dedicated channel.

According to some embodiments, the valve system may further comprise a cooling medium source valve arranged at the cooling medium source. The cooling medium source valve may be arranged at different locations and may be configured to control the flow of cooling medium from the cooling medium source to the channel system of the cooling system.

According to some embodiments, the cooling system controller may further be configured to, upon determination that a battery module is in thermal runaway, activate the valve system to open the module valve at the channel dedicated to the battery module. When the module valve is open, the cooling system controller may further be configured to open the cooling medium source valve to release the predefined amount of cooling medium into the battery module.

Opening a valve from a pressurized liquid source into a closed channel system may result in a sudden pressure impulse in the closed channel system. Any valves arranged in such a closed channel system may have to be adapted or dimensioned to such a pressure impulse.

Opening the module valve prior to opening the cooling medium source valve may reduce or remove any such pressure impulse in the channel system of the cooling system.

According to some embodiments, the cooling system controller may be configured to determine that a battery module is in thermal runaway based on a difference between two temperature measurements, made at a predefined time interval, said difference being larger than a threshold value.

In a faulty battery cell (and thus faulty battery module), the temperature may increase quickly (a so-called thermal runaway). By comparing two temperature measurement made at a predefined time interval, an increase in temperature may be detected.

According to some embodiments, each battery module may comprise at least four temperature sensors arranged at different positions inside the battery module.

For example, each battery module may comprise six, eight, ten, or more temperature sensors. The temperature sensors may be positioned to allow for at least two independent sensors to detect a rapid temperature change, which may indicate a thermal event/runaway, in the module.

The temperatures reached in a thermal runaway may damage sensors. Arranging a plurality of sensors inside the module may provide that a thermal event may be detected even if one or more sensors are damaged.

According to some embodiments, each battery module may further comprise at least one carbon monoxide sensor. The cooling system controller may further be configured to determine that a battery module is in thermal runaway based on a signal received from the carbon monoxide sensor of the battery module.

According to some embodiments, the energy storage system may further comprise a cabinet in which the at least one battery stack and the cooling system are arranged.

Energy storage systems can be located in remote and/or unsupervised places. Battery modules are valuable and are often subject to theft. Further, battery modules may be dangerous. Therefore, in order to protect the battery modules, or to protect the surroundings and/or people nearby, an energy storage system may be arranged inside a cabinet.

According to a second aspect of the present disclosure, a method for cooling a battery module in an energy storage system is provided. The energy storage system comprises at least one battery stack comprising at least one battery module. Each of the at least one battery module comprises a plurality of temperature sensors. The energy storage system further comprises a cooling system comprising a cooling medium source and a channel system arranged to selectively provide cooling medium from the cooling medium source to each of the at least one battery module by means of a valve system. The method comprises receiving signals from the temperature sensors of the at least one battery module. The method further comprises determining, based on the received signals, that a battery module of the at least one battery module is in thermal runaway. The method further comprises activating the valve system to selectively release a predefined amount of cooling medium into the battery module in thermal runaway.

According to some embodiments, the determination that the battery module is in thermal runaway may comprise determining that a difference between two temperature measurements, made at a predefined time interval, is larger than a threshold value.

According to some embodiments, the channel system may include a dedicated channel for each of the at least one battery module. The valve system may include a plurality of individually controllable module valves each arranged in connection with a respective dedicated channel and configured to control a cooling medium flow from the cooling medium source to the respective dedicated channel. The valve system may further comprise a cooling medium source valve arranged at the cooling medium source. The method may further comprise, upon determination that a battery module is in thermal runaway, activating the valve system to open the module valve at the channel dedicated to the battery module. When the module valve is open, the method may further comprise opening the cooling medium source valve to release the predefined amount of cooling medium into the battery module.

It is noted that other embodiments using all possible combinations of features recited in the above-described embodiments may be envisaged. Thus, the present disclosure also relates to all possible combinations of features mentioned herein.

### BRIEF DESCRIPTION OF DRAWINGS

Exemplifying embodiments will now be described in more detail, with reference to the following appended drawings:

FIG. 1 illustrates an energy storage system, in accordance with some embodiments;

FIG. 2 illustrates a battery module, in accordance with some embodiments;

FIG. 3 illustrates an energy storage system, in accordance with some embodiments;

FIG. 4 illustrates a cooling medium source, in accordance with some embodiments; and

FIG. 5 illustrates an energy storage system arranged in a cabinet, in accordance with some embodiments.

As illustrated in the figures, the sizes of the elements and regions may be exaggerated for illustrative purposes and, thus, are provided to illustrate the general structures of the embodiments. Like reference numerals refer to like elements throughout.

### DETAILED DESCRIPTION

Exemplifying embodiments will now be described more fully hereinafter with reference to the accompanying drawings in which currently preferred embodiments are shown. The invention may, however, be embodied in many different forms and should not be construed as limited to the embodiments set forth herein; rather, these embodiments are provided for thoroughness and completeness, and fully convey the scope of the invention to the skilled person.

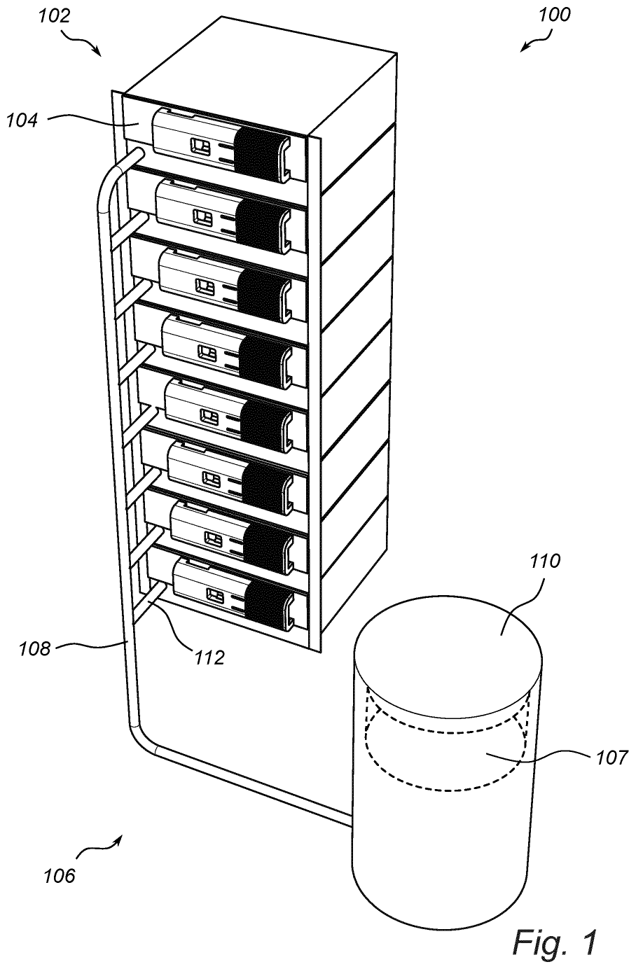

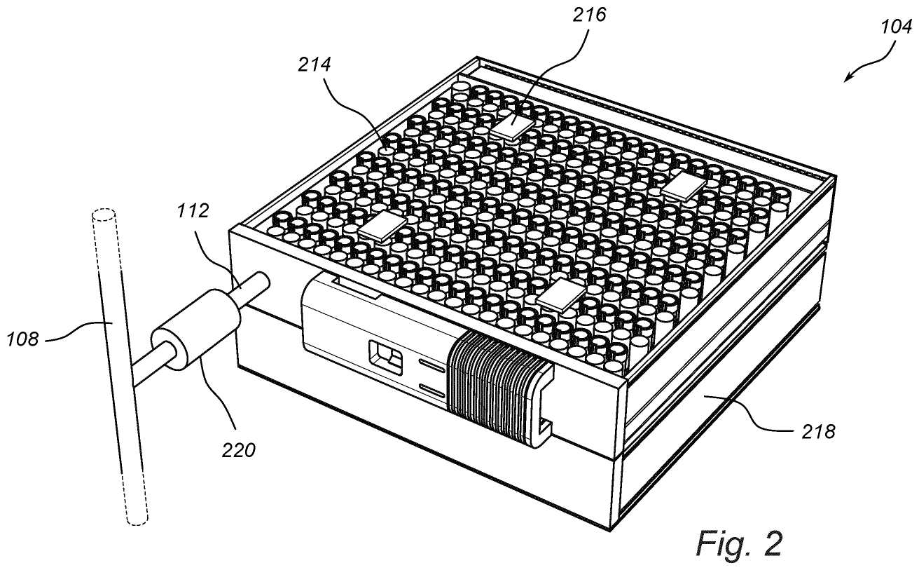

With reference to FIGS. 1 and 2, an energy storage system, in accordance with some embodiments, will be described.

FIG. 1 illustrates an energy storage system 100. The energy storage system comprises a battery stack 102 and a cooling system 106.

The battery stack 102 comprises a plurality of battery modules 104. The illustrated battery stack 102 comprises eight battery modules 104, however the number of battery modules may vary. For example, a stack 102 may comprise seventeen battery modules 104.

FIG. 2 provides further details of a battery module 104. The battery module 104 comprises a plurality battery cells 214 (together forming a battery cell pack) arranged inside a housing 218. If a fault occurs in one of the cells 214, chemical reactions inside the cell 214 may cause the cell to rapidly heat up. The cell 214 may go into thermal runaway. The increasing temperature of a cell 214 may in turn heat neighboring cells 214, which may start a chain reaction. If left unchecked, the battery module 104 may catch fire or explode.

Each module 104 in the stack 102 comprises a plurality of temperature sensors 216. In FIG. 2, four sensors 216 are schematically illustrated. However, the number of sensors inside a module 104 may vary. For example, a module 104 may comprise eight temperature sensors 216. The sensors 216 are distributed inside the battery module 104, to actively monitor the temperature in different parts of the module 104. The distribution of the sensors 216 may provide that different sensors 216 may more quickly detect temperature changes in different parts of the module 104. Further, if one or more sensors 216 are damaged by high temperature, one or more other sensors, arranged in a different part of the module 104, may still function.

The module 104 may further comprise other types of sensors, such as carbon monoxide sensors.

The sensors 216 may be in communication with a cooling system controller 107. The cooling system controller 107 is illustrated as forming part of the cooling medium source 110 (or as being arranged in the same unit as the cooling medium source). However, the cooling system controller 107 may for example form part of, or be distributed between, at least one of an EES controller, a BMS, and a separate cooling system controller. Below, details of the operation of the cooling system will be provided as operational tasks performed by the cooling system, or specifically by its controller. It will be appreciated that the operational tasks may be expressed as steps of a method.

The cooling system controller may receive measurements from the sensors 216 of each of the battery modules 104 in the stack 102. Based on measurements received from the sensors 216, the cooling system controller 107 may determine that a battery module 104 is in thermal runaway. For example, the cooling system controller 107 may compare measurements from different sensors 216 within a module 104 to detect a change in temperature between different positions within the module 104. The cooling system controller 107 may compare measurements from the same, or different, sensors 216 made over time to monitor a change in temperature over time. For example, the cooling system controller 107 may determine that a battery module 104 is in thermal runaway based on a difference between two temperature measurements, made at a predefined time interval, the difference being larger than a threshold value. The cooling system controller may further compare measurements from sensors 216 of different modules 104, to monitor changes in temperature between the different modules 104.

The cooling system 106 further comprises a cooling medium source 110 and a channel system 108. The channel system 108 is arranged to selectively provide cooling medium, from the cooling medium source 110, to each of the at least one battery module 104 by means of a valve system (not depicted in FIG. 1). The valve system may comprise a system of electrically controlled valves, such as solenoid valves.

In FIGS. 1 and 2, the channel system 108 comprises a main channel and a plurality of dedicated channels 112. Each one of the dedicated channels 112 connects the main channel to a respective battery module 104. The valve system comprises a plurality of individually controllable valves 220 (illustrated in FIG. 2). Each of the individually controllable module valves 220 is arranged in connection with a respective dedicated channel and configured to control a cooling medium flow from the cooling medium source 110 to (or through) the respective dedicated channel 112.

The valves of the valve system may normally be in a closed state, such that cooling medium does not spread from the cooling medium source 110, through the channel system 108, to the modules 104. Upon detection, or determination, that a battery module 104 is in thermal runaway, the cooling system controller 107 may control the valve system to selectively release a predefined amount of cooling medium into the battery module 104 in thermal runaway. The cooling medium is directed only to the affected module 104. A limited (predefined) amount of cooling medium, such as e.g., 20 litres, can thus be used. Using a limited amount of cooling medium may minimize the risk for water damage to other modules or the area surrounding the stack. If the modules 104 are watertight, the modules 104 below the affected module may not necessarily be damaged by the cooling medium.

In the embodiment illustrated in FIGS. 1 and 2, the cooling system controller 107 may open the dedicated valve 220 to allow a cooling medium to flow from the cooling medium source 110, through the channel system 108, through the dedicated channel 220 and into the module 104 to cool the cells 214. As only one of the valves 220 is open, the cooling medium flows to, and into, only the concerned module 104.

The cooling medium source 110 may be a pressurized source of cooling medium. For some systems, a cooling medium source 110 can be connected to a plurality of stacks.

The cooling medium source may be a pressurized tank, as in FIG. 1, which may provide a stand-alone energy storage system 100. Alternatively, the cooling system can be connected to a water supply. In such embodiments, the water supply may be the cooling medium source.

In a pressurized tank, the amount of cooling medium may be limited to the amount of cooling medium necessary to cool a single module 104. For example, the amount may be adapted to fill the module 104. Potentially, the predefined amount may be slightly larger than the volume 104 of a module, such as 5-10% larger. Alternatively, the tank may comprise a larger amount of cooling medium. For example, the tank may comprise enough cooling medium to cool two or more modules 104.

In solutions where the available amount of cooling medium is larger than what is necessary to cool a single module, a timer or a flow sensor may be coupled to the cooling medium source 110. The timer or a flow sensor may be in communication with the cooling system controller. The cooling system controller may control a flow from the cooling medium source 110, based on the timer (if the flow rate is known) or the flow sensor such that the flow from the cooling medium source is turned off once the predetermined amount of cooling medium has been released into the module.

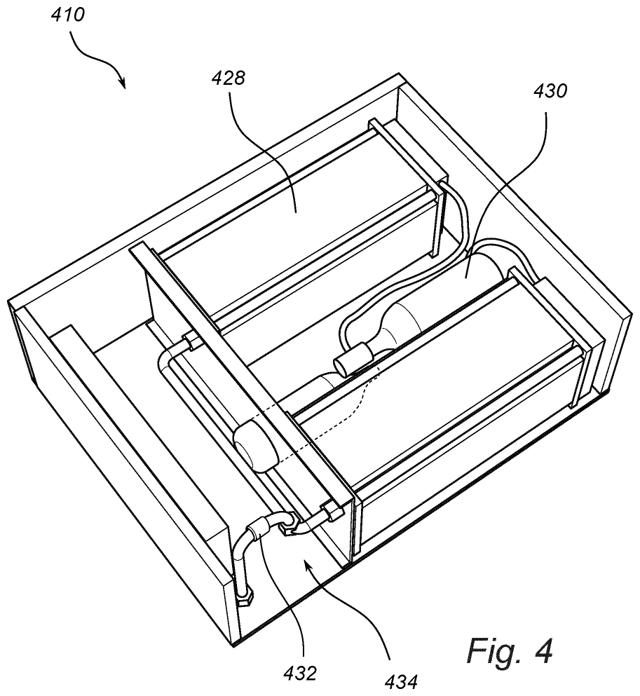

The valve system may further comprise a cooling medium source valve (such as valve 432 in FIG. 4) arranged at the cooling medium source 110. The cooling medium source valve may control a flow of cooling medium from the cooling medium source 110 into the channel system 108. The cooling system controller 107 may, upon detection of thermal runaway in a battery module 104, first open the module valve 220 at the channel 112 dedicated to the battery module 104. When the module valve 220 is open, the cooling system controller 107 may open the cooling medium source valve to release the predefined amount of cooling medium into the battery module 104. When the valve 220 associated with the concerned module 104 is opened first, the channel system 108 may not be subject to a pressure shock when the pressurized cooling medium is released into the system 108. This may allow the use of less advanced module valves 220.

Inside the module 104, the cooling medium may be distributed in different ways. In one example, the cooling medium may flow into the module 104 along a side of the module 104, to spread around and between the cells 214. In another example, the battery module 104 may comprise a tube or a pipe (not depicted) arranged within the housing 218 of the battery module 104. The tube or pipe may comprise a number of holes, to allow the cooling medium to spread from the tube or pipe and through the module 104.

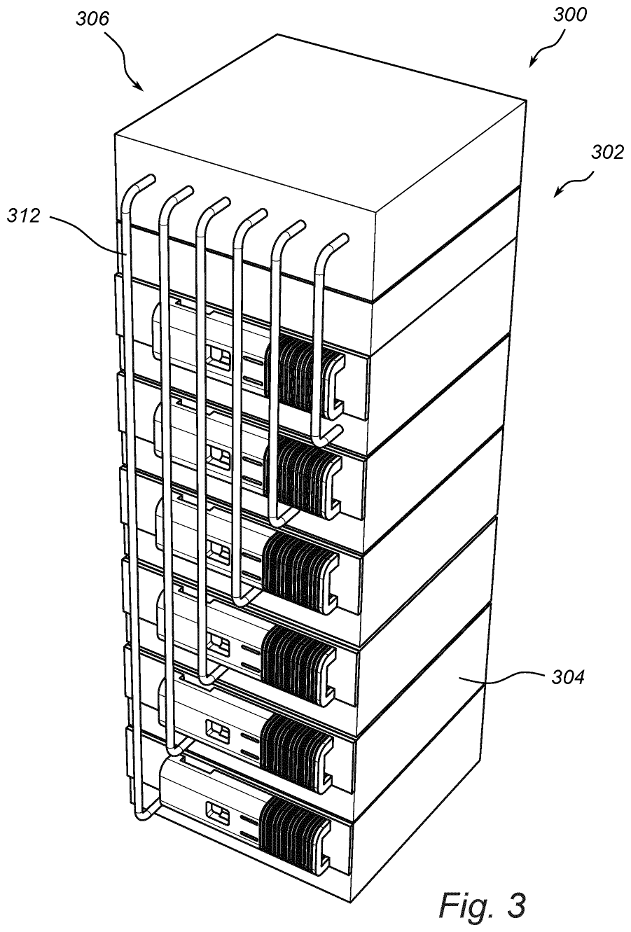

FIG. 3 illustrates an energy storage system 300, equivalent to the energy storage system 100 described above with reference to FIGS. 1 and 2, except in the arrangement of the cooling system 306 and its channel system.

In FIG. 3, the cooling system 306 is arranged on top of the stack 302. The cooling system 306 comprises the cooling medium source and the valve system. In the cooling system 306, there is one valve per module 304 in the stack 302. Each valve is connected to a dedicated channel (or tube) 312 which is connected to an associated module 304 in the stack 302.

FIG. 4 illustrates a cooling medium source 410 which may be arranged on top of a battery stack 302, such as in the cooling system 306 illustrated in FIG. 3.

The cooling medium source 410 comprises two cooling medium tanks 428. The cooling medium of each of the cooling medium tanks 428 is pressurized by a pressurized cartridge 430. Exit channels from each of the cooling medium tanks 428 are connected by a manifold to a common channel 434. At the common channel 434, a cooling medium source valve 432 is arranged to control a flow of cooling medium out of the cooling medium source 410.

The common channel 434 may for example be connected to each of the valves in the valve system described with reference to FIG. 3.

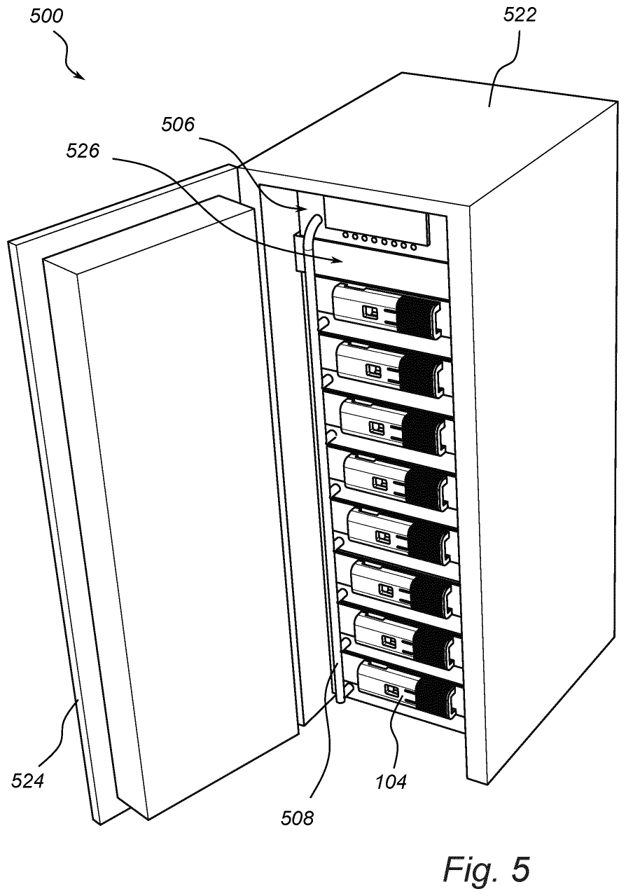

FIG. 5 illustrates a further embodiment of an energy storage system 500. The energy storage system 500 may be equivalent to the energy storage systems 100, 300 described above with reference to FIGS. 1-4.

The energy storage system comprises a stack of battery modules 104 and a cooling system 506 arranged inside a cabinet 522. The energy storage system 500 further comprises a battery management system (BMS) 526. The BMS 526 may manage the battery modules 104. For example, the BMS may monitor the battery modules 104, balance a charge of the battery modules 104 etc. The BMS 526 may also comprise at least parts of the cooling system controller. The BMS 526 may be configured to perform some of the processes of the cooling system controller.

The cooling system 506 is equivalent to the cooling system 306 described with reference to FIG. 3 except in that the channel system 508 is equivalent to the channel system 108 described with reference to FIGS. 1 and 2. In other embodiments, the channel system 508 of the cooling system 506 shown in FIG. 5 may be replaced with a channel system 312 such as described with reference to FIG. 3.

The cabinet 522 may act as a frame for holding the stack of modules 104 and the cooling system 506. The cabinet 522 may be a security cabinet, with thick walls and a lockable door 524. A security cabinet may prevent unauthorized access to the battery modules 104. A security cabinet may further prevent fire from spreading to other stacks or prevent cooling medium released into a module from spreading outside the cabinet 522.

The person skilled in the art realizes that the present invention by no means is limited to the preferred embodiments described above. On the contrary, many modifications and variations are possible within the scope of the appended claims.

Although features and elements are described above in particular combinations, each feature or element can be used alone without the other features and elements or in various combinations with or without other features and elements.

Additionally, variations to the disclosed embodiments can be understood and effected by the skilled person in practicing the claimed invention, from a study of the drawings, the disclosure, and the appended claims. In the claims, the word “comprising” does not exclude other elements, and the indefinite article “a” or “an” does not exclude a plurality. The mere fact that certain features are recited in mutually different dependent claims does not indicate that a combination of these features cannot be used to advantage.

### Itemized List of Embodiments

1. An energy storage system (100), comprising:
at least one battery stack (102) comprising at least one battery module (104), each of the at least one battery module comprising a plurality of temperature sensors (216); and
a cooling system (106) comprising:
   a cooling medium source (110);
   a channel system (108) arranged to selectively provide cooling medium from said cooling medium source to each of the at least one battery module by means of a valve system, and
   a cooling system controller (107);
wherein the cooling system controller is configured to:
   determine, based on signals received from the temperature sensors of said at least one battery module, that a battery module is in thermal runaway; and
   activate the valve system to selectively release a predefined amount of cooling medium into the battery module in thermal runaway.
2. The energy storage system of item 1, wherein said predefined amount of cooling medium is adapted to the volume of a single battery module.
3. The energy storage system of any of the preceding items, wherein said cooling medium source is a pressurized tank (428) comprising the predefined amount of cooling medium.
4. The energy storage system of any one of the preceding items, wherein said cooling medium is water.
5. The energy storage system of any of items 1-2, wherein:
said cooling medium source is a water supply;
said cooling system further comprises a flow sensor; and
said cooling system controller is further configured to stop the water supply when the predefined amount has been released into the battery module, based on an input from the flow sensor.
6. The energy storage system of any of the preceding items, wherein:
said channel system includes a dedicated channel (112) for each of the at least one battery module; and
said valve system includes a plurality of individually controllable module valves (220) each arranged in connection with a respective dedicated channel and configured to control a cooling medium flow from the cooling medium source to the respective dedicated channel.
7. The energy storage system of item 6, wherein:
said valve system further comprises a cooling medium source valve (432) arranged at the cooling medium source.
8. The energy storage system of item 7, wherein said cooling system controller is further configured to, upon determination that a battery module is in thermal runaway, activate the valve system to:
open the module valve at the channel dedicated to the battery module; and
when the module valve is open, open the cooling medium source valve to release the predefined amount of cooling medium into the battery module.
9. The energy storage system of any of the preceding items, wherein the cooling system controller is configured to determine that a battery module is in thermal runaway based on a difference between two temperature measurements, made at a predefined time interval, said difference being larger than a threshold value.
10. The energy storage system of any of the preceding items, wherein each battery module comprises at least four temperature sensors arranged at different positions inside the battery module.
11. The energy storage system of any of the preceding items, wherein each battery module further comprises at least one carbon monoxide sensor, and wherein said cooling system controller is further configured to determine that a battery module is in thermal runaway based on a signal received from the carbon monoxide sensor of the battery module.
12. The energy storage system of any of the preceding items, further comprising a cabinet (522) in which the at least one battery stack and the cooling system are arranged.
13. A method for cooling a battery module (104) in an energy storage system (100), the energy storage system comprising at least one battery stack (102) comprising at least one battery module, each of the at least one battery module comprising a plurality of temperature sensors (216), and a cooling system (106) comprising a cooling medium source (110) and a channel system (108) arranged to selectively provide cooling medium from said cooling medium source to each of the at least one battery module by means of a valve system, the method comprising:
receiving signals from the temperature sensors of the at least one battery module;
determining, based on the received signals, that a battery module of the at least one battery module is in thermal runaway; and
activating the valve system to selectively release a predefined amount of cooling medium into the battery module in thermal runaway.
14. The method of item 13, wherein determining that the battery module is in thermal runaway comprises determining that a difference between two temperature measurements, made at a predefined time interval, is larger than a threshold value.
15. The method of any of items 13 or 14, wherein said channel system includes a dedicated channel (112) for each of the at least one battery module, and said valve system includes:
a plurality of individually controllable module valves (220) each arranged in connection with a respective dedicated channel and configured to control a cooling medium flow from the cooling medium source to the respective dedicated channel, and
a cooling medium source valve arranged at the cooling medium source;
the method further comprising, upon determination that a battery module is in thermal runaway, activating the valve system to:
open the module valve at the channel dedicated to the battery module; and
when the module valve is open, open the cooling medium source valve to release the predefined amount of cooling medium into the battery module.

1. An energy storage system, comprising:
at least one battery stack comprising at least one battery module each of the at least one battery module comprising a plurality of temperature sensors; and
a cooling system comprising:
a pressurized cooling medium source;
a channel system including a dedicated channel for each of the at least one battery module, the channel system being arranged to selectively provide cooling medium from said cooling medium source to each of the at least one battery module by means of a valve system including a plurality of individually controllable module valves each arranged in connection with a respective dedicated channel and configured to control a cooling medium flow from the cooling medium source to the respective dedicated channel, the valve system further comprising a cooling medium source valve arranged at the cooling medium source; and
a cooling system controller;
wherein the cooling system controller is configured to:
determine, based on signals received from the temperature sensors of said at least one battery module, that a battery module is in thermal runaway;
upon determination that a battery module is in thermal runaway, activate the valve system to:
open the module valve at the channel dedicated to the battery module in thermal runaway; and
when the module valve is open, open the cooling medium source valve to selectively release a predefined amount of cooling medium into the battery module in thermal runaway.

2. The energy storage system of claim 1, wherein the battery module comprises a housing in which the battery cell pack is arranged, and said predefined amount of cooling medium is 5-10% larger than the volume of a single battery module as determined by the housing.

3. The energy storage system of claim 1, wherein said cooling medium is water.

4. The energy storage system of claim 1, wherein:
said cooling system further comprises a flow sensor; and
said cooling system controller is further configured to stop the cooling medium source when the predefined amount has been released into the battery module, based on an input from the flow sensor.

5. The energy storage system of claim 1, wherein:
said cooling system further comprises a timer; and
said cooling system controller is further configured to:
determine that the predefined amount has been released into the battery module based on an input from the timer and a known flow rate of the cooling medium, and
stop the cooling medium source when the predefined amount has been released into the battery module.

6. The energy storage system of claim 4, wherein the cooling medium source is a water supply.

7. The energy storage system of claim 1, wherein said cooling medium source is a pressurized tank comprising the predefined amount of cooling medium.

8. The energy storage system of claim 1, wherein the cooling system controller is configured to determine that a battery module is in thermal runaway based on a difference between two temperature measurements, made at a predefined time interval, said difference being larger than a threshold value.

9. The energy storage system of claim 1, wherein each battery module comprises at least four temperature sensors arranged at different positions inside the battery module.

10. The energy storage system of claim 1, wherein each battery module further comprises at least one carbon monoxide sensor, and wherein said cooling system controller is further configured to determine that a battery module is in thermal runaway based on a signal received from the carbon monoxide sensor of the battery module.

11. The energy storage system of claim 1, further comprising a cabinet in which the at least one battery stack and the cooling system are arranged.

12. A method for cooling a battery module in an energy storage system, the energy storage system comprising at least one battery stack comprising at least one battery module, each of the at least one battery module comprising a plurality of temperature sensors, and a cooling system comprising a pressurized cooling medium source and a channel system including a dedicated channel for each of the at least one battery module, the channel system being arranged to selectively provide cooling medium from said cooling medium source to each of the at least one battery module by means of a valve system including a plurality of individually controllable module valves each arranged in connection with a respective dedicated channel and configured to control a cooling medium flow from the cooling medium source to the respective dedicated channel, the valve system further comprising a cooling medium source valve arranged at the cooling medium source, the method comprising:
receiving signals from the temperature sensors of the at least one battery module;
determining, based on the received signals, that a battery module of the at least one battery module is in thermal runaway;
upon determination that a battery module is in thermal runaway activating the valve system to:
open the module valve at the channel dedicated to the battery module in thermal runaway; and
when the module valve is open, open the cooling medium source valve to selectively release a predefined amount of cooling medium into the battery module in thermal runaway.

13. The method of claim 12, wherein determining that the battery module is in thermal runaway comprises determining that a difference between two temperature measurements, made at a predefined time interval, is larger than a threshold value.
